(19) United States
(12) Patent Application Publication
(10) Pub. No.: US 2014/0151208 A1
(43) Pub. Date: Jun. 5, 2014

(54) SIMPLE ASSEMBLY THIN KEYBOARD

(71) Applicant: ZIPPY TECHNOLOGY CORP., New Taipei City (TW)

(72) Inventor: Chin-Wen CHOU, New Taipei City (TW)

(73) Assignee: ZIPPY TECHNOLOGY CORP., New Taipei City (TW)

(21) Appl. No.: 13/692,750

(22) Filed: Dec. 3, 2012

(51) Int. Cl. H01H 13/7065

(52) U.S. Cl. CPC H01H 13/7065
USPC 200/5 A

(57) ABSTRACT

A simple assembly thin keyboard includes at least one circuit board and a plurality of keycap assembly located on the circuit board and movable vertically to press the circuit board to generate keyboard command signals. The keycap assembly includes a plurality of first keycaps and second keycaps. Each first keycap abuts at least one second keycaps. The abutting first keycaps and second keycaps are interposed by a plurality of connection arms. Each connection arm includes at least one first connecting section connecting to the first keycap, at least one second connecting section connecting to the second keycap and an elastic section which bridges the first connecting section and second connecting section and contains at least one stress reversion spot. Through the connection arm bridged the first and second keycaps to substitute the conventional driven mechanism total thickness of the keyboard can be reduced, and assembly also is simpler.

### FIELD OF THE INVENTION

The present invention relates to a keyboard and particularly to a thin keyboard with connection arms to bridge keycaps to reduce keyboard thickness.

### BACKGROUND OF THE INVENTION

There are numerous types of input devices for computer systems, such as optical disk drives, mouse, keyboards and the like. Among them keyboards are most commonly used. A conventional keyboard, such as one disclosed in R.O.C. patent Nos. 445471, 1220213 and M346861, generally includes a keycap, a circuit board triggered by the keycap to generate a command signal, a baseboard located at one side of the circuit board, and a driven mechanism with two ends connecting to the keycap and baseboard. In the aforesaid keyboard structure, the keycap receives a force to move against the circuit board. The driven mechanism is depressed downwards to press and set on a circuit switch on the circuit board to generate a corresponding control signal. When the keycap does not receive the force and not move towards the circuit board, the driven mechanism provides a return elastic force to push the keycap away from the circuit board at a selected elevation relative to the circuit board in a regular condition. Although the keyboard thus formed can achieve the object of entering commands, the driven mechanism is formed at a certain height that is added to the height of the keyboard. There days requirements of computer design heavily focus on thin and lightweight. Take a notebook computer for instance, the thickness of the keyboard module is the major factor affecting the total thickness of the notebook computer. Almost all computer makers have devoted a great deal of efforts and investments trying to make the keyboard structure thinner.

To overcome the aforesaid problem, other types of keyboard designs have been proposed. For instance, R.O.C. patent M434979 discloses a keycap formed in a V-shaped structure by coupling a first support member and a second support member to overcome the thickness problem created by the X-shaped structure of the conventional driven mechanism. R.O.C. patent M419973 discloses an extensible lift structure between the keycap and circuit board to substitute the conventional driven mechanism to facilitate miniaturization. R.O.C. patent M426075 proposes a keycap surrounded by a first support member and a second support member to substitute the conventional driven mechanism to reduce total keyboard thickness. Eventually, all the aforesaid techniques merely try to change the implementation approach of the driven mechanism. They still have substantial thickness, and the structures are quite complex and assembly is difficult.

### SUMMARY OF THE INVENTION

The primary object of the present invention is to provide a thin keyboard with connection arms to bridge keycaps to overcome the thickness problem of the conventional keyboards caused by the driven mechanism that makes thinning impossible.

To achieve the foregoing object the present invention provides a thin keyboard which includes at least one circuit board and a plurality of keycap assembly located on the circuit board and movable vertically to press the circuit board to generate keyboard command signals. The keycap assembly includes a plurality of first keycaps and second keycaps abutting each other. The abutting first keycap and second keycap are interposed by a plurality of connection arms. Each connection arm includes at least one first connecting section connecting to the first keycap, at least one second connecting section connecting to the second keycap and an elastic section which bridges the first connecting section and second connecting section and contains at least one stress reversion spot.

In one embodiment the thin keyboard further includes a frame which has at least one housing zone to hold the keycap assembly. The first keycap or second keycap and the abutting the frame are bridged by the connection arm. The keycap assembly is held in the housing zone and arranged in a horizontal or vertical manner. The keycap assembly includes a support rib located between the neighboring housing zones. More specifically, the frame and support rib include a retaining portion abutting the circumference of the first keycap and second keycap to form a retaining zone. The retaining portion is located correspondingly to a side corner position of the first keycap and second keycap, or correspondingly to a lateral side of the first keycap and second keycap where no connection arm is located.

In another embodiment the first keycap and second keycap have a depressible first upper surface and a lower surface. The lower surface has a contact portion extended towards the circuit board.

In yet another embodiment the first keycap and second keycap and the circuit board are interposed by a movement zone. The movement zone contains an elastic support member to aid movements of the first keycap and second keycap relative to the circuit board. More specifically, the elastic support member includes a trigger portion depressible by the first keycap or second keycap to connect the circuit board to generate the keyboard command signals. The elastic support member can be located in the center or one of four corners of the first keycap and second keycap.

In yet another embodiment the frame includes a support arm between the first keycap and second keycap to connect to the elastic section to provide ancillary support.

In yet another embodiment the connection arm bridges opposing lateral sides of the first keycap and second keycap.

In yet another embodiment the first keycap and second keycap include a depressible first upper surface, a second upper surface formed at an elevation difference against the first upper surface, and a lower surface facing the circuit board. The connection arm bridges opposing lateral sides of the second upper surface of the first keycap and second keycap.

Through the aforesaid structure, compared with the conventional keyboards, the invention provides features as follow:

1. Total keyboard thickness can be reduced. The invention has a connection arm located between the first keycap and second keycap to provide a return force after the first and second keycaps are depressed to replace the conventional driven mechanism, hence the problem of thickness constraint caused by the driven mechanism can be overcome, and the keyboard can be made thinner.

2. Assembly of the keyboard is simpler. Through the connection arm provided by the invention, assembly can be accomplished without inter-latching of multiple structures, hence the keyboard can be assembled easier.

3. Simplified keyboard structure. Compared with the conventional keyboard relied on a baseboard and a driven mechanism that require a lot of related assembly structures, the thinner keyboard of the invention does not have driven mechanism, hence there is also no related assembly work on the baseboard. As a result, assembly operation of the thin keyboard is simpler.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is top view of the frame of an embodiment of the thin keyboard of the invention prior to assembly.

FIG. 1B is a fragmentary enlarged view according to FIG. 1A.

FIG. 2 is a schematic view of an embodiment of the thin keyboard of the invention in an assembly condition.

FIG. 3A is a schematic view of the keycap of an embodiment of the thin keyboard of the invention before depressed.

FIG. 3B is a schematic view of the keycap of an embodiment of the thin keyboard of the invention after depressed.

FIG. 4 is a top view of a second embodiment of the thin keyboard of the invention.

FIG. 5 is a top view of a third embodiment of the thin keyboard of the invention.

FIG. 6 is a top view of a first embodiment of the thin keyboard of the invention.

FIG. 7 is an exploded view of a fourth embodiment of the thin keyboard of the invention.

FIG. 8 is a side view of a fifth embodiment of the thin keyboard of the invention.

FIG. 9 is a side view of a sixth embodiment of the thin keyboard of the invention.

FIG. 10 is a side view of a seventh embodiment of the thin keyboard of the invention.

FIG. 11 is a top view of an eighth embodiment of the thin keyboard of the invention.

FIG. 12 is a side view of the eighth embodiment of the thin keyboard of the invention.

### DETAILED DESCRIPTION OF THE PREFERRED EMBODIMENTS

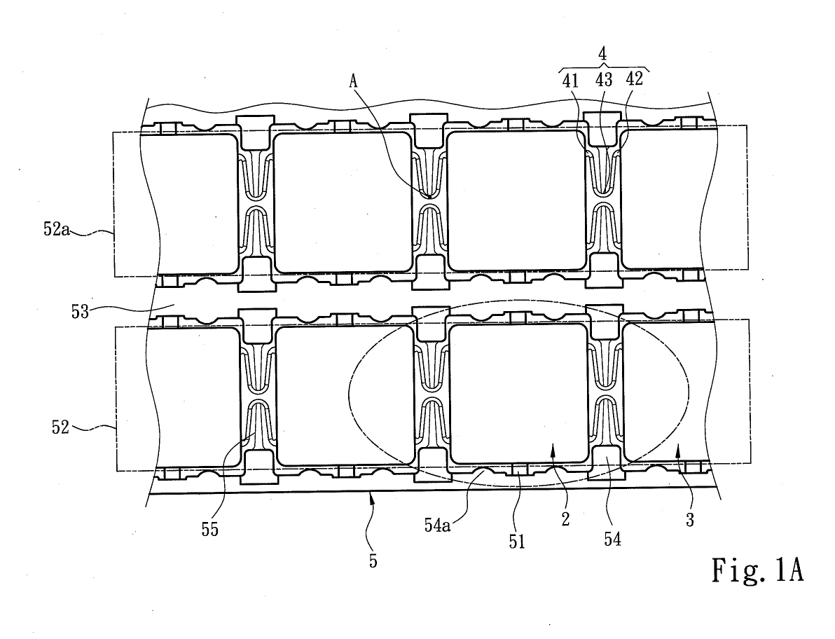

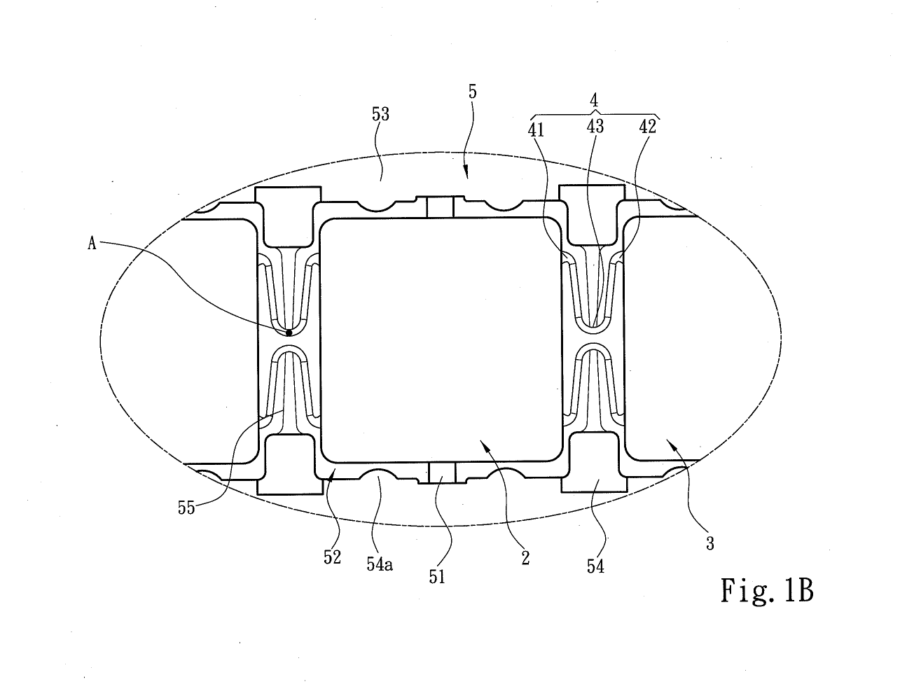

Please referring to FIGS. 1A, 1B and 2, the present invention aims to provide a simple assembly thin keyboard without driven mechanisms of the conventional keyboards to make total structure of the keyboard thinner. The thin keyboard according to the invention includes at least one circuit board 1 and a plurality of keycap assembly located on the circuit board that are movable vertically to connect the circuit board 1 to generate keyboard command signals. The keycap assembly includes a plurality of first keycaps 2 and second keycaps 3 abutting each other, and a plurality of connection arms 4 located between the abutting first and second keycaps 2 and 3. Each connection arm 4 has at least one first connecting section 41 connecting to the first keycap 2, at least one second connecting section 42 connecting to the second keycap 3 and one elastic section 43 to bridge the first connecting section 41 and second connecting section 42. More specifically, the elastic section 43 has at least one stress reversion spot A. After the first keycap 2 or second keycap 3 has been vertically moved to connect the circuit board 1, the elastic section 43 provides a return force to return the depressed first keycap 2 or second keycap 3 to a regular condition.

It is to be noted that the thin keyboard mentioned herein can be assembled in many ways, only one type of assembly process is taken as an example for discussion in this invention, but not the limitation of the invention. Fabrication and assembly process of the invention is elaborated as follow:

a). circuit board fabrication step: provide the circuit board 1 including a plurality of command portions 11 to generate keyboard command signals;

b). keycap fabrication step: fabricate a frame 5 and a plurality of first keycaps 2 and second keycaps 3 located in the frame 5 via an integrated injection process. The frame 5 and first keycaps 2 and second keycaps 3 are bridged by a material injection strip 51 formed during the injection process. More specifically, the abutting first keycap 2 and second keycap 3 are interposed by the connection arms 4. Each connection arm 4 has at least one first connecting section 41 connecting to the first keycap 2 and one second connecting section 42 connecting to the second keycap 3. The first connecting section 41 and second connecting section 42 are bridged by the elastic section 43 which contains at least one stress reversion spot A; and

c). keycap and circuit board assembly step: assemble the frame 5 and circuit board 1, with the first keycaps 2 and second keycaps 3 on the frame 5 aligned with the command portions 11 of the circuit board 1; then sever the material injection strip 51 between the frame 5 and first keycaps 2 or second keycaps 3 via a preset equipment (not shown in the drawings) to finish fabrication of the thin keyboard of the invention.

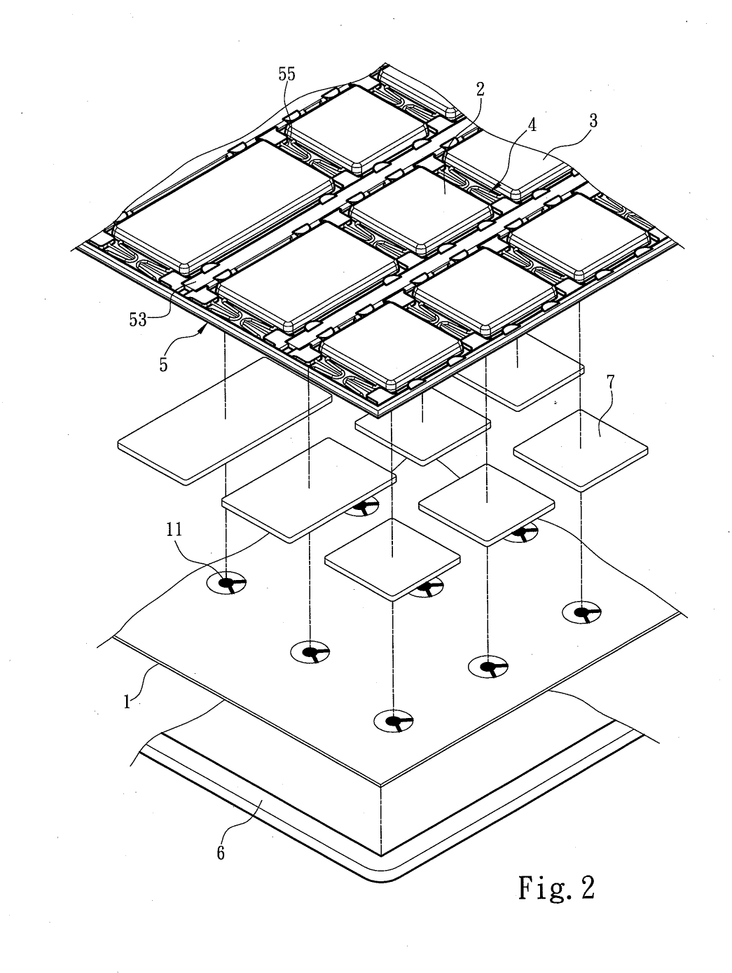

For assembly of the thin keyboard, place the circuit board 1 in a keyboard housing 6, then assemble the frame 5 and keyboard housing 6. Referring to FIGS. 3A and 3B, after assembly of the thin keyboard is finished, the first and second keycaps 2 and 3 are spaced from the circuit board 1 at a selected distance through support of the frame 5, and the first and second keycaps 2 and 3 and the circuit board 1 form a movement zone between them. More specifically, the first keycap 2 or second keycap 3 can be moved in the movement zone to trigger the circuit board 1 to generate a keyboard command signal. To facilitate discussion, the second keycap 3 is taken as an example herein. When the second keycap 3 receives a force and is depressed and moved towards the circuit board 1, the second connecting section 42 also is driven by the second keycap 3 to move vertically and force the elastic section 43 to generate deformation. The stress reversion spot A dissipates the stress transmitted from the second keycap 3 during the movement, thereby the first keycap 2 abutting the second keycap 3 is not driven. When the force applied on the second keycap 3 is absent, the elastic section 43 returns to its regular condition and drives the second keycap 3 to return to the condition before depressed.

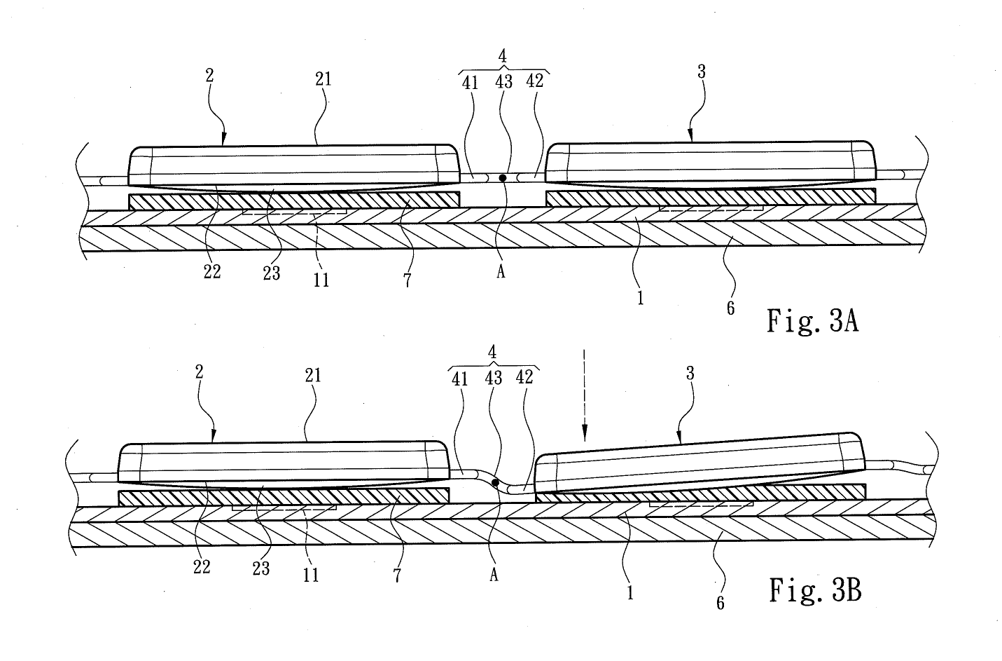

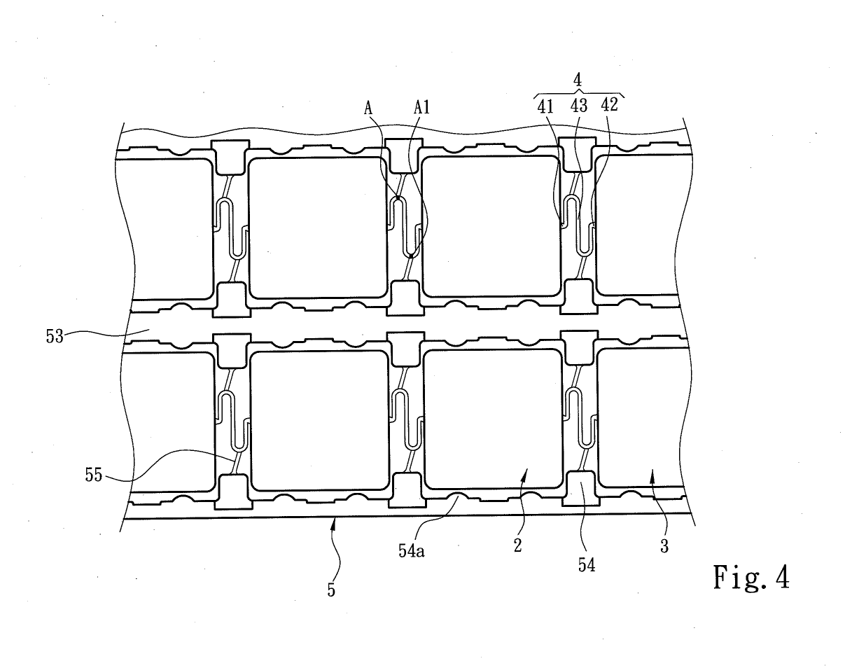

The connection arm 4, aside from the embodiment previously discussed, can also be changed as desired according to user's keystroke feel or intended elastic return degree. The connection arm 4 has at least one stress reversion spot A. FIG. 4 illustrates another embodiment in which the connection arm 4 has two stress reversion spots A and A1 to form like a S shape. FIG. 5 depicts yet another embodiment in which the connection arm 4 has more than two stress reversion spots A, A1 and A2 to form an undulate fashion. In practice, the connection arm 4 can also be formed in many other styles, the embodiments previously discussed serve merely for illustrative purpose and are not the limitations of the invention.

Please referring to FIGS. 1A and 1B, the frame 5 further includes a housing zone 52 to hold the keycap assembly. More specifically, the housing zone 52 is located on the frame 5 where the first and second keycaps 2 and 3 are positioned. The first keycap 2 or second keycap 3 abutting the frame 5 is bridged by the connection arm 4 therebetween as shown in FIG. 2. The second keycap 2 or third keycap 3 at the outmost side of the housing zone 52 and adjacent to the frame 5 also is bridged by the connection arm 5 with the frame 5. More specifically, the keycap assembly consisting of the first keycap 2 and second keycap 3 is held in the housing zone 52 and arranged horizontally or vertically. The keycap assembly include a support rib 53 located between the neighboring housing zones 52 and 52a in the frame 5. The support rib 53 is formed in the arranged direction of the keycap assembly, i.e. if the keycap assembly is laid horizontally, the support rib 53 also is formed horizontally.

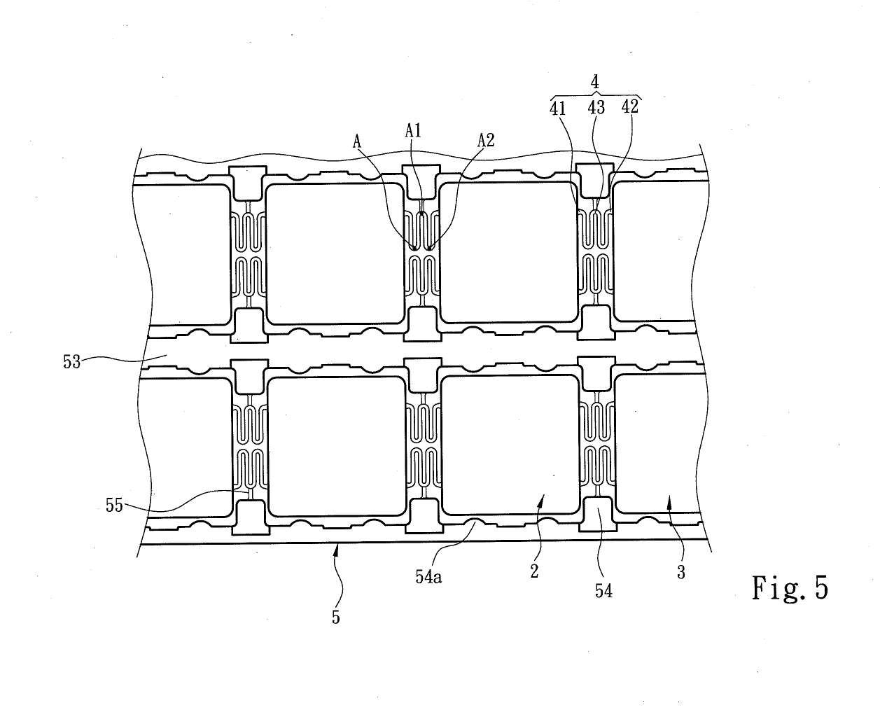

Please referring to FIG. 6, the frame 5 and support rib 53 further have a retaining portion 54 abutting the circumference of the first keycap 2 and second keycap 3 to form a retaining zone. More specifically, the retaining portion 54 can be located correspondingly to a side corner position of the first and second keycaps 2 and 3, or correspondingly to a lateral side of the first and second keycaps 2 and 3 where no connection arm 4 is located, as shown by 54a. The retaining portions 54 and 54a are not limited to be located on the frame 5, also can be located on the support rib 53. The retaining portions 54 and 54a can prevent the first keycap 2 or second keycap 3 from skewing towards the support rib 53 or another keycap when depressed by users on different spots. Also referring to FIG. 1A, the frame 5 further has a support arm 55 located between the first keycap 2 and second keycap 3. The support arm 55 further is connected to the elastic section 43 of the connection arm 4. When the first keycap 2 or second keycap 3 is not depressed, the support arm 55 supports the connection arm 4; when the first keycap 2 or second keycap 3 is depressed, the support arm dissipates the stress generated by the first keycap 2 or second keycap 3 caused by depressing.

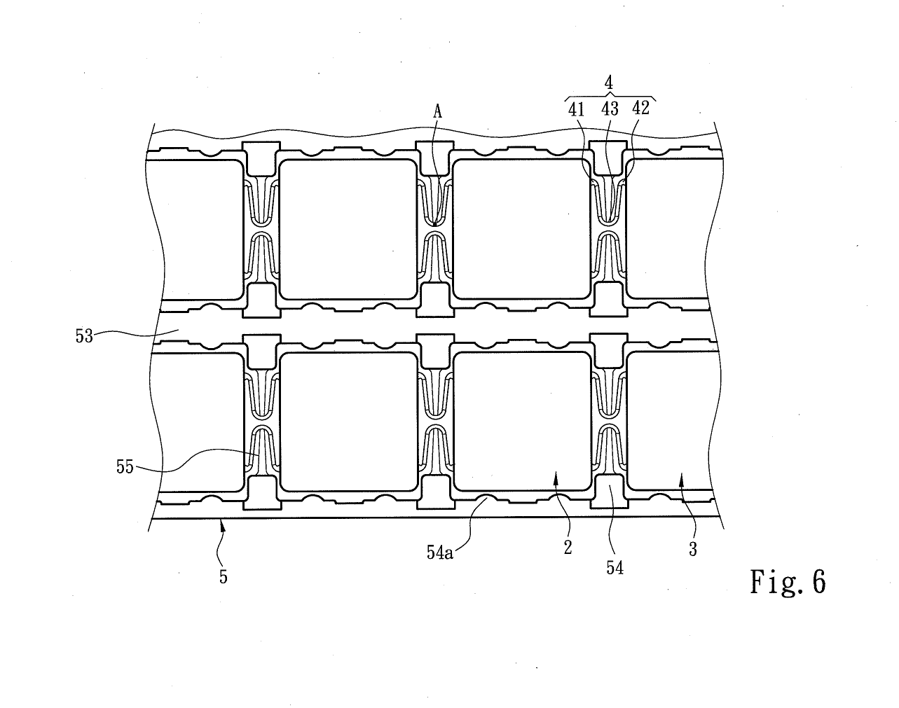

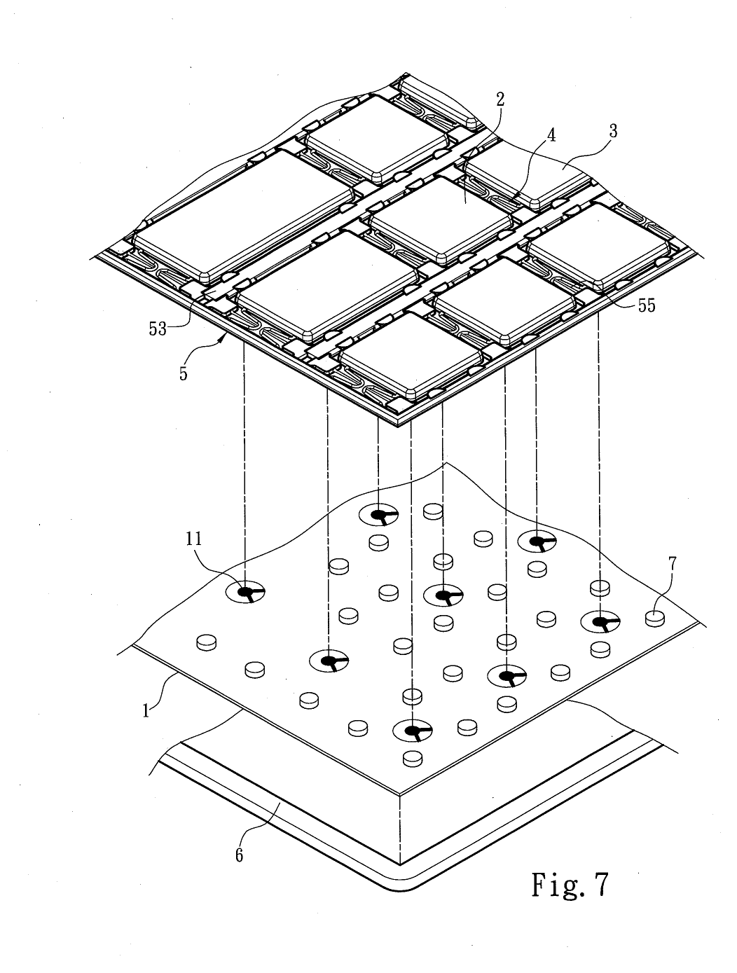

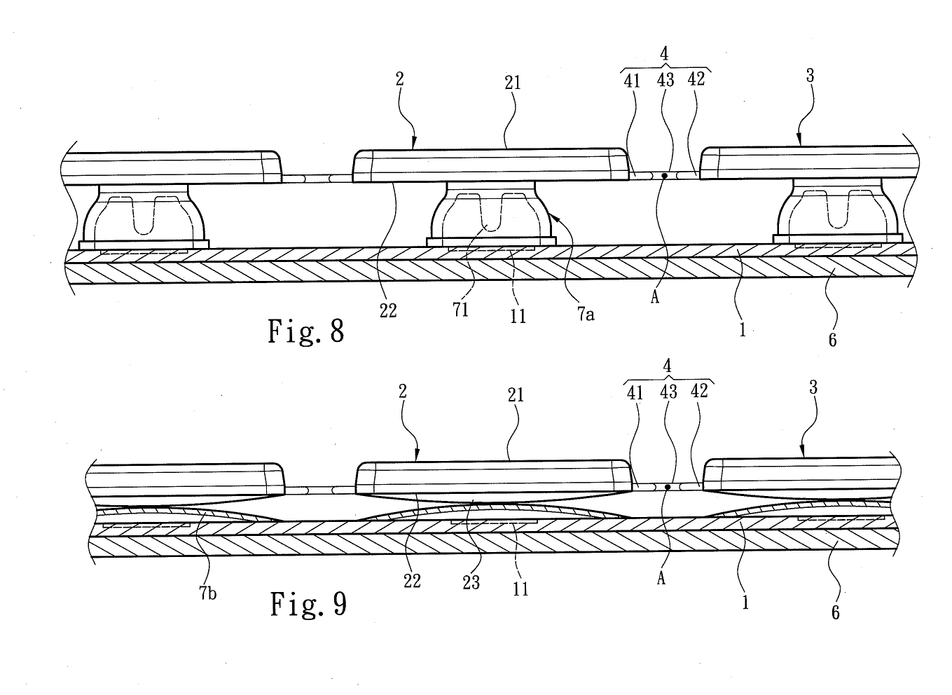

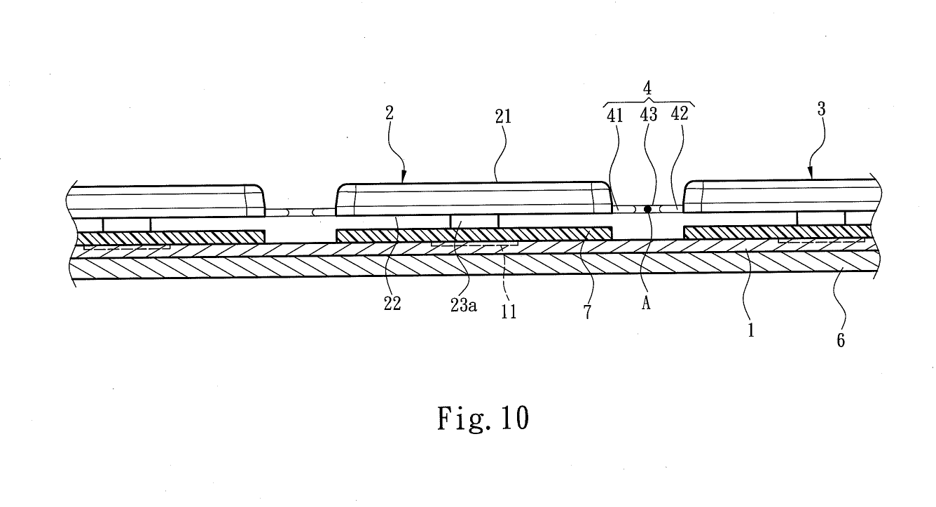

Please referring to FIGS. 2 and 3A, the first keycap 2 further has a depressible first upper surface 21 and a lower surface 22. The lower surface 22 has a contact portion 23 extended towards the circuit board 1. The second keycap 3 is structured same as the first keycap 2, thus details are omitted. The movement zone between the first keycap 2 and second keycap 3 and the circuit board 1 can include an elastic support member 7 to aid movement of the first keycap 2 and second keycap 3 against the circuit board 1. The elastic support member 7 can be located in the center of the first keycap 2 and second keycap 3, or at a corner position of the first keycap 2 and second keycap 3 as shown in FIG. 7. Also referring to FIG. 8, the elastic support member 7 can further have a trigger portion 71 depressible by the first keycap 2 or second keycap 3 to connect the circuit board 1 to generate the keyboard command signals. More specifically, the elastic support member 7 can be an elastic element 7a used in the conventional keyboard, or a dome-shaped elastic reed 7b as shown in FIG. 9. The contact portion 23 can also be changed according to requirements, such as an arched structure shown in FIG. 9, or a strut structure shown by 23a in FIG. 10.

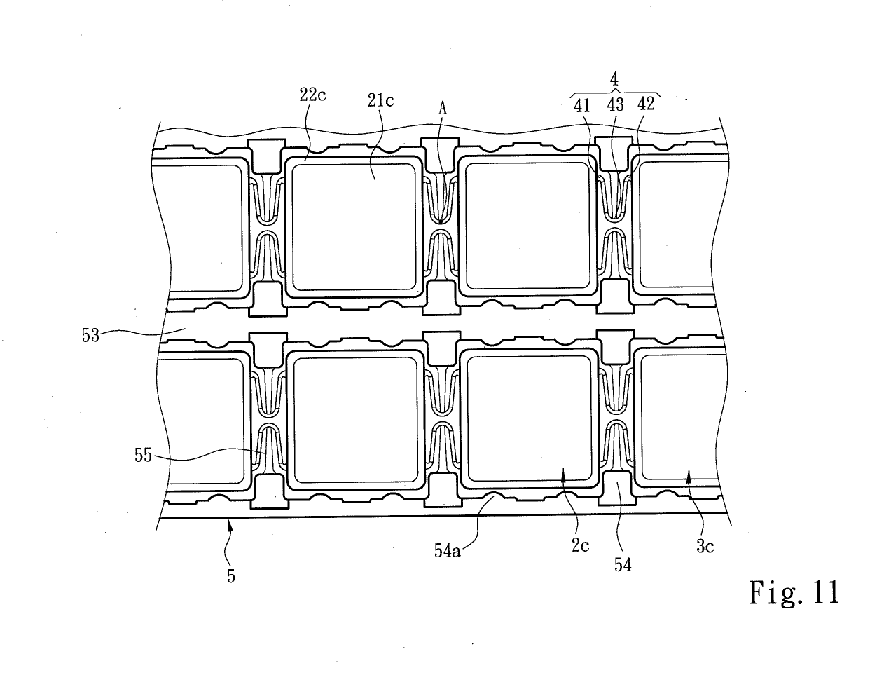

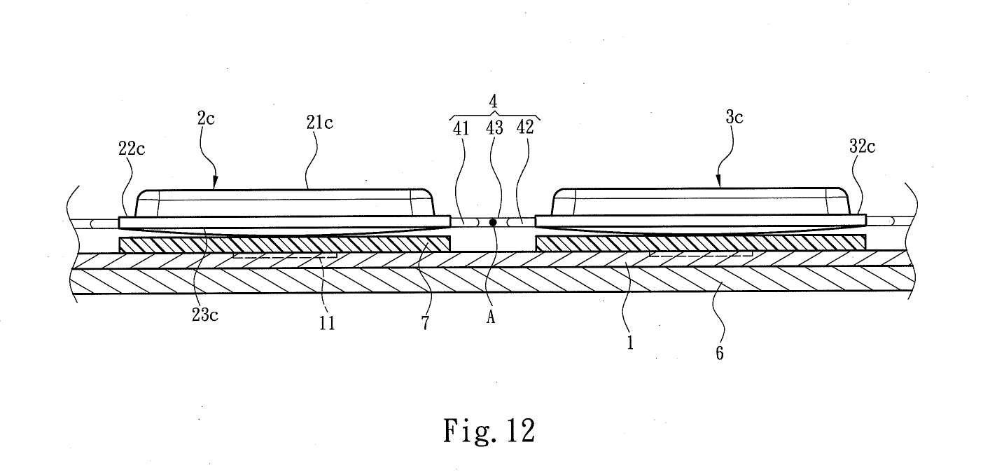

Please referring to FIG. 3A, the connection arm 4 can be located at opposing lateral sides of the first keycap 2 and second keycap 3. Two types of keycaps are generally adopted in the industry, one is shown in FIG. 3A, the other is shown in FIG. 11, in which the first keycap 2c has a first upper surface 21c, a second upper surface 22c formed at an elevation difference with the first upper surface 21c and a lower surface 23c facing the circuit board. The second keycap 3c is structured same as the first keycap 2c, hence details are omitted. Furthermore, the connection arm 4 is connected to the opposing lateral sides of the second upper surfaces 22c and 32c of the first and second keycaps 2c and 3c, as shown in FIG. 12.

As a conclusion, the simple assembly thin keyboard of the invention mainly employs the connection arm between the first and second keycaps to substitute the conventional driven mechanism to generate the same effect, hence the thickness of the keyboard can be reduced. Without the height constraint of the driven mechanism, the keyboard can be made thinner and lighter in weight, and also can be adaptable to other products with design requirements of thin and lightweight.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A simple assembly thin keyboard, comprising at least one circuit board and a plurality of keycap assembly located on the circuit board and movable vertically to connect the circuit board to generate keyboard command signals, characterized in that the keycap assembly including:
a plurality of first keycaps and second keycaps, each first keycap abutting at least one second keycap; and
a plurality of connection arms located between the abutting first keycaps and second keycaps, each connection arm including at least one first connecting section connecting to the first keycaps, at least one second connecting section connecting to the second keycaps and an elastic section bridging the first connecting section and the second connecting section and containing at least one stress reversion spot.

2. The simple assembly thin keyboard of claim 1 further including a frame which contains at least one housing zone to hold the keycap assembly, the first keycaps or the second keycaps abutting the frame being bridged by the connection arms therebetween.

3. The simple assembly thin keyboard of claim 2, wherein the keycap assembly is held and arranged horizontally or vertically in the housing zone, the keycap assembly having a support rib located between the abutting housing zones.

4. The simple assembly thin keyboard of claim 3, wherein the frame and the support rib include a retaining portion abutting the circumference of the first keycaps and the second keycaps to form a retaining zone.

5. The simple assembly thin keyboard of claim 4, wherein the retaining portion is located correspondingly to a side corner position of the first keycaps and the second keycaps.

6. The simple assembly thin keyboard of claim 4, wherein the retaining portion is located correspondingly to a lateral side of the first keycaps and the second keycaps where no connection arm is located.

7. The simple assembly thin keyboard of claim 5, wherein the retaining portion is located correspondingly to a lateral side of the first keycaps and the second keycaps where no connection arm is located.

8. The simple assembly thin keyboard of claim 2, wherein the frame includes a support arm between the first keycaps and the second keycaps and connecting to the elastic section to provide ancillary support.

9. The simple assembly thin keyboard of claim 1, wherein each first keycap and second keycap includes a depressible first upper surface and a lower surface, the lower surface including a contact portion extended towards the circuit board.

10. The simple assembly thin keyboard of claim 1, wherein the first keycaps or the second keycaps and the circuit board are interposed by a movement zone which contains an elastic support member to aid the first keycaps and the second keycaps to move against the circuit board.

11. The simple assembly thin keyboard of claim 10, wherein the elastic support member includes a trigger portion depressible by the first keycaps or the second keycaps to connect the circuit board to generate the keyboard command signals.

12. The simple assembly thin keyboard of claim 10, wherein the elastic support member is located in the center of the first keycap and the second keycap.

13. The simple assembly thin keyboard of claim 10, wherein the elastic support member is located at four corners of the first keycaps and the second keycaps.

14. The simple assembly thin keyboard of claim 2, wherein both the first keycaps and the second keycaps include a depressible first upper surface and a lower surface, the lower surface including a contact portion extended towards the circuit board.

15. The simple assembly thin keyboard of claim 2, wherein the first keycaps or the second keycaps and the circuit board are interposed by a movement zone which contains an elastic support member to aid the first keycaps and the second keycaps to move against the circuit board.

16. The simple assembly thin keyboard of claim 15, wherein the elastic support member includes a trigger portion depressible by the first keycaps or the second keycaps to connect the circuit board to generate the keyboard command signals.

17. The simple assembly thin keyboard of claim 15, wherein the elastic support member is located in the center of the first keycap and the second keycap.

18. The simple assembly thin keyboard of claim 15, wherein the elastic support member is located at four corners of the first keycaps and the second keycaps.

19. The simple assembly thin keyboard of claim 1, wherein the connection arm is located at opposing lateral sides of the first keycaps and the second keycaps.

20. The simple assembly thin keyboard of claim 1, wherein the both first keycaps and the second keycaps include a depressible first upper surface, a second upper surface formed at an elevation difference with the first upper surface and, a lower surface facing the circuit board, the connection arm bridging opposing lateral sides of the second upper surfaces of the first keycaps and the second keycaps.
